(19) United States
(12) Patent Application Publication
(10) Pub. No.: US 2007/0046204 A1
(43) Pub. Date: Mar. 1, 2007

(54) Plasma display panel

(75) Inventor: Woong-Kee Min, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/507,575

(22) Filed: Aug. 22, 2006

(30) Foreign Application Priority Data
Aug. 23, 2005 (KR) 10-2005-0077445

(51) Int. Cl. H01J 17/49

(52) U.S. Cl. 313/582

(57) ABSTRACT

A plasma display panel is disclosed. The plasma display panel includes a substrate, and a transverse barrier rib and a longitudinal barrier rib formed on an upper portion of the substrate to form discharge cells. At least one of the transverse barrier rib and the longitudinal barrier rib includes a first barrier rib and a second barrier rib spaced apart from each other. The shape of the first barrier rib is different from the shape of the second barrier rib.

This Nonprovisional application claims priority under 35 U.S.C. § 119(a) on Patent Application No. 10-2005-0077445 filed in Korea on Aug. 23, 2005 the entire contents of which are hereby incorporated by reference.

### BACKGROUND

1. Field

This document relates to a plasma display panel.

2. Description of the Background Art

A plasma display panel comprises a phosphor layer formed inside a discharge cell partitioned by barrier ribs and a plurality of electrodes through which a driving signal is supplied to the discharge cell.

When supplying the driving signal to the discharge cell, a discharge gas filled in the discharge cell generates vacuum ultraviolet rays, which thereby cause phosphors formed inside the discharge cell to emit light, thus displaying an image.

### SUMMARY

Embodiments provide a plasma display panel capable of reducing a loss of power caused by a reactive power when driving the plasma display panel, by reducing a capacitance of a barrier rib.

The embodiments also provide a plasma display panel capable of increasing driving efficiency due to an expansion of a discharge space by improving the structure of a barrier rib.

The embodiments also provide a plasma display panel capable of smoothly exhausting an impure gas by improving the structure of a barrier rib.

In an aspect, there is provided a plasma display panel comprising a substrate, and a transverse barrier rib and a longitudinal barrier rib formed on an upper portion of the substrate to form discharge cells, wherein at least one of the transverse barrier rib and the longitudinal barrier rib comprises a first barrier rib and a second barrier rib spaced apart from each other, and the shape of the first barrier rib is different from the shape of the second barrier rib.

Implementations may include one or more of the following features. For example, the shape of the first barrier rib or the second barrier rib is a straight-line shape, and the shape of the remaining barrier rib is a shape different from the straight-line shape.

In another aspect, there is provided a plasma display panel comprising a substrate, and a transverse barrier rib and a longitudinal barrier rib formed on an upper portion of the substrate to form a discharge cell, wherein at least one of the transverse barrier rib and the longitudinal barrier rib comprises a first barrier rib and a second barrier rib spaced apart from each other at an unequal distance.

In still another aspect, there is provided a plasma display panel comprising a front substrate comprising a first electrode and a second electrode formed in parallel to each other, a rear substrate comprising a third electrode which is formed to intersect the first electrode and the second electrode, and a transverse barrier rib and a longitudinal barrier rib for forming discharge cells between the front substrate and the rear substrate, wherein at least one of the transverse barrier rib and the longitudinal barrier rib comprises a first barrier rib and a second barrier rib spaced apart from each other, and a distance between a reference line between the first barrier rib and the second barrier rib and the first barrier rib is different from a distance between the reference line and the second barrier rib.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 schematically illustrates the structure of a plasma display panel according to an embodiment;

FIG. 2 is a plane view of the structure of a barrier rib of the plasma display panel according to the embodiment;

FIG. 3 is a plane view of the structure of a barrier rib of a plasma display panel according to another embodiment; and

FIG. 4 is a plane view of an electrode and the structure of a barrier rib of a plasma display panel according to still another embodiment.

### DETAILED DESCRIPTION OF EXAMPLE EMBODIMENTS

Reference will now be made in detail embodiments of the invention examples of which are illustrated in the accompanying drawings.

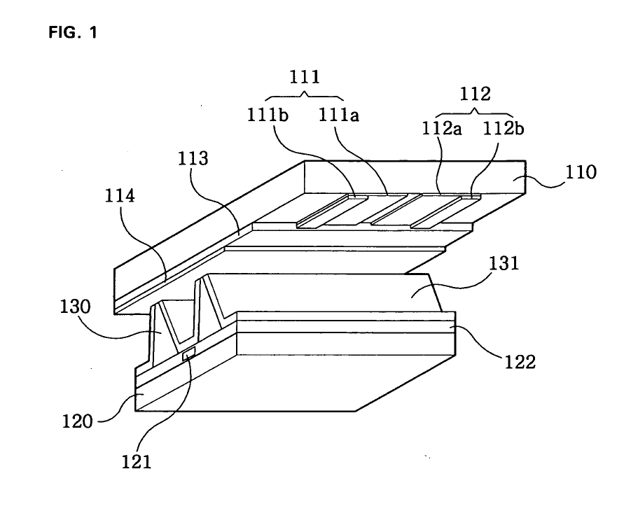

FIG. 1 schematically illustrates the structure of a plasma display panel according to an embodiment.

Referring to FIG. 1, the plasma display panel according to the embodiment comprises a front substrate and a rear substrate which are coalesced in parallel to each other at a given distance therebetween.

The front substrate comprises a first electrode 111, a second electrode 112 formed on a substrate 110, an upper dielectric layer 113 for covering the first electrode 111 and the second electrode 112, and a protective layer 114 formed on the upper dielectric layer 113. The first electrode 111 and the second electrode 112 are formed in pairs to form maintenance electrode pair.

The rear substrate comprises a third electrode 121 (hereinafter, referred to as an address electrode) formed on a substrate 120, a lower dielectric layer 122 for covering the address electrode 121, a barrier rib 130 formed on the lower dielectric layer 122, and a phosphor layer 131 formed inside a discharge cell formed by the barrier rib 130.

The maintenance electrode pair 111 and 112 each comprise stripe-shaped transparent electrodes 111a and 112a and metal electrodes 111b and 112b. The transparent electrodes 111a and 112a have a relatively wide width and are made of a transparent indium-tin-oxide (ITO) material for transmitting visible light. The metal electrodes 111b and 112b have a relatively narrow width and compensate resistance of the transparent electrodes 111a and 112a. The transparent electrodes 111a and 112a of the maintenance electrode pair 111 and 112 oppose to each other at a predetermined gap therebetween.

A formation location of the metal electrodes 111b and 112b of the maintenance electrode pair 111 and 112 may depend on the shape of the discharge cell. However, the metal electrodes 111b and 112b are formed at an edge of one side of each of the transparent electrodes 111a and 112a so that the metal electrodes 111b and 112b are located to the outside of the discharge cell. In other words, the metal electrodes 111b and 112b are formed at the outside edges of the transparent electrodes 111a and 112a.

The maintenance electrode pair 111 and 112 comprises a scan electrode and a sustain electrode in the terms of a function.

The scan electrode 111 is supplied with a scan signal for scanning of the plasma display panel and a sustain signal for discharge maintenance. The sustain electrode 112 is mainly supplied with a sustain signal.

The upper dielectric layer 113 and the lower dielectric layer 122 provide insulation of the electrodes when driving the plasma display panel.

The protective layer 114 prevents a damage to the upper dielectric layer 113 caused by Ag sputtering, thereby increasing lifespan of the plasma display panel and increasing a secondary electron emission coefficient. The protective layer 114 is generally made of MgO.

The address electrode 121 is formed to intersect the maintenance pair 111 and 112. The address electrode 121 is supplied with a data signal for selecting a discharge cell.

The barrier rib 130 is formed in parallel to the address electrode 121 to prevent ultraviolet rays generated by a discharge from being leaked into an adjacent discharge cell. The structure of the barrier rib 130 will be described in detail later.

Red, green or blue phosphors are coated inside the discharge cell formed by the barrier rib 130 such that the phosphor layer 131 generates one of Red, green or blue visible light.

A discharge gas, for example, an inert gas such as a mixture of He and Xe, a mixture of Ne and Xe, a mixture of He, Xe and Ne is injected into the inside of the plasma display panel.

In the plasma display panel of the above-described structure, an opposite discharge occurs between the address electrode 121 and the scan electrode 111 to select the discharge cell. Then, a surface discharge occurs between the maintenance electrode pair 111 and 112 to maintain a discharge state of the discharge cell selected by performing the opposite discharge.

The surface discharge for discharge maintenance generates ultraviolet rays, which thereby cause the phosphor layers 131 to emit light, thus emitting visible light to the outside of the discharge cell.

In such a case, the plasma display panel represents gray scale required in displaying an image by controlling a discharge maintenance period of a cell, i.e., the number of sustain discharges in accordance with video data.

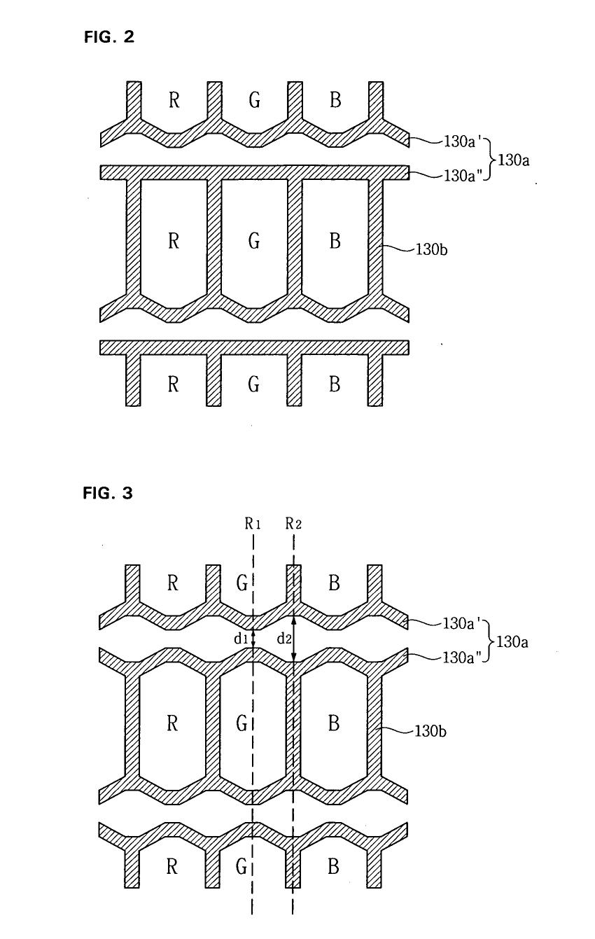

FIG. 2 is a plane view of the structure of a barrier rib of the plasma display panel according to the embodiment.

Referring to FIG. 2, the barrier rib of the plasma display panel according to the embodiment comprises a transverse barrier rib 130a and a longitudinal barrier rib 130b to form the discharge cells on the substrate. The transverse barrier rib 130a and the longitudinal barrier rib 130b may be formed on the front substrate or the rear substrate.

In such a case, the transverse barrier rib 130a partitions the discharge cells each including the same phosphor, and the longitudinal barrier rib 130b partitions the discharge cells each including a different phosphor.

At least one of the transverse barrier rib 130a and the longitudinal barrier rib 130b forms an exhaust passage. In FIG. 2, the explanation will be given of an example of the transverse barrier rib 130a as the barrier rib for forming the exhaust passage. The transverse barrier rib 130a may comprise a first barrier rib 130a′ and a second barrier rib 130a″ spaced apart from each other to smoothly exhaust impurities. As described above, the longitudinal barrier rib 130b may comprise a first barrier rib and a second barrier rib spaced apart from each other for smoothly exhausting impurities.

A distance between the first barrier rib 130a′ and the second barrier rib 130a″ may be unequal throughout the substrate. Further, the distance between the first barrier rib 130a′ and the second barrier rib 130a″ may be unequal in a portion of the whole substrate.

More specifically, the distance between the first barrier rib 130a′ and the second barrier rib 130a″ may increase or decrease at a given rate throughout the substrate. Further, the distance between the first barrier rib 130a′ and the second barrier rib 130a″ may increase or decrease at a given rate in a portion of the whole substrate.

In other words, the first barrier rib 130a′ and the second barrier rib 130a″ have different shapes. For example, as illustrated in FIG. 2, the second barrier rib 130a″ may have a straight-line shape throughout the substrate. The first barrier rib 130a′ may have a zigzag shape or other shapes different from the straight-line shape throughout the substrate. On the contrary, the first barrier rib 130a′ may have a straight-line shape throughout the substrate, and the second barrier rib 130a″ may have a zigzag shape or other shapes different from the straight-line shape throughout the substrate.

The above-described structure of the barrier rib widens the size of the discharge cell formed by the barrier rib, thereby improving the driving efficiency of the plasma display panel.

The phosphor for generating visible light when driving the plasma display panel is coated inside the discharge cell formed by the barrier rib. However, the phosphor is not coated between the first barrier rib 130a′ and the second barrier rib 130a″. The dielectric layer for covering the electrode formed on the substrate is formed between the first barrier rib 130a′ and the second barrier rib 130a″. As a result, a mixed color of the visible light is prevented.

Since the plasma display panel including the exhaust passage reduces a capacitance of the barrier rib, a loss of power caused by a reactive power generated when driving the plasma display panel decreases.

Further, the protective layer with high moisture absorption and the porous phosphor layer of the plasma display panel comprise a large amount of impure gas. The large amount of impure gas remains inside the plasma display panel, thereby causing problems such as image sticking and an unstable discharge. Accordingly, life span of the plasma display panel decreases. However, the plasma display panel according to the embodiment comprises the exhaust passage, thereby suppressing the remaining of the impure gas through the exhaust passage.

FIG. 3 is a plane view of the structure of a barrier rib of a plasma display panel according to another embodiment.

The structure of the barrier rib of the plasma display panel illustrated in FIG. 3 is almost the same as the structure of the barrier rib of the plasma display panel illustrated in FIG. 2, and thus a description about the same portion is omitted.

In the barrier rib of the plasma display panel according to another embodiment, a distance between a first barrier rib 130a′ and a second barrier rib 130a″ of a transverse barrier rib 130a is unequal throughout a substrate. More specifically, the first barrier rib 130a′ and the second barrier rib 130a″ have the same shape, for example, a zigzag shape. The shape of the first barrier rib 130a′ is symmetrical to the shape of the second barrier rib 130a″.

Although it is not illustrated in FIG. 3, the first barrier rib 130a′ and the second barrier rib 130a″ may have a streamline shape in the structure of the zigzag shaped barrier rib to smoothly exhaust an impure gas.

In the plasma display panel of the above-described structure, a shortest distance d1 between the first barrier rib 130a′ and the second barrier rib 130a″ is equal to a distance between the first barrier rib 130a′ and the second barrier rib 130a″ corresponding to a first reference line R1 passing through the center of a discharge cell in a direction of a longitudinal barrier rib 130b.

The size of the discharge cell increases by the barrier rib of the above-described structure, and thus the driving efficiency of the plasma display panel increases.

More specifically, the distance d1 between the first barrier rib 130a′ and the second barrier rib 130a″ corresponding to the first reference line R1 is less than a distance d2 between the first barrier rib 130a′ and the second barrier rib 130a″ corresponding to a second reference line R2 passing through the longitudinal barrier rib 130b.

The distance between the first barrier rib 130a′ and the second barrier rib 130a″ may depend on definition of the plasma display panel. Preferably, the distance between the first barrier rib 130a′ and the second barrier rib 130a″ ranges from 20 μm to 500 μm. In such a case, the driving conditions of the plasma display panel depending on an exhaust characteristic, the capacitance of the barrier rib or the size of the discharge cell other than the definition of the plasma display panel are efficiently satisfied.

The discharge cell formed by the barrier rib may have various shapes. In FIG. 3, the discharge cell has a hexagon shape.

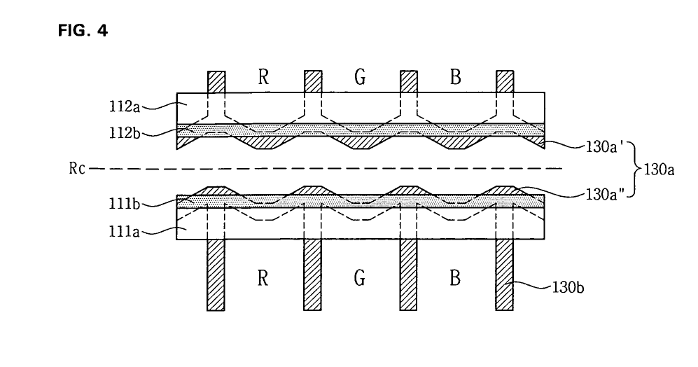

FIG. 4 is a plane view of an electrode and the structure of a barrier rib of a plasma display panel according to still another embodiment.

The structure of the barrier rib of the plasma display panel illustrated in FIG. 4 is almost the same as the structure of the barrier rib of the plasma display panel illustrated in FIG. 2, and thus a description about the same portion is omitted.

In the barrier rib of the plasma display panel according to still another embodiment, a first barrier rib 130a′ and a second barrier rib 130a″ of a transverse barrier rib 130a have the same shape. A distance between the first barrier rib 130a′ and the second barrier rib 130a″ is uniform throughout a substrate.

A distance between a reference line Rc between the first barrier rib 130a′ and the second barrier rib 130a″ and the first barrier rib 130a′ is different from a distance between the reference line Rc and the second barrier rib 130a″.

In such a case, metal electrodes 111b and 112b of a first electrode and a second electrode included in a front substrate of the plasma display panel are formed on a substrate corresponding to the first barrier rib 130a′ and the second barrier rib 130a″.

This prevents a reduction in the brightness caused by opacity of the metal electrodes 111b and 112b when driving the plasma display panel.

Although the plasma display panel was described separately in each of the embodiments, the various shape of the barrier rib or the various electrode structures described in each of the embodiments may be integrated into one embodiment.

The barrier rib of the plasma display panel may be manufactured using any method known to those skilled in the art. For example, a screen printing method, an etching method, a sandblasting method, a squeezing method or a paste photolithography method using a photosensitive paste may be used to manufacture the barrier rib.

The following is a detailed description of the method of forming the barrier rib of the plasma display panel using a screen printing method.

A barrier rib material such as a frit glass paste is printed on the substrate by a predetermined thickness and is then dried. Afterwards, a screen printing process is repeatedly performed on the resulting structure several tens of times in the same place to form the barrier rib with the desired height. A firing process is performed on the barrier rib with the desired height at a high temperature using a firing furnace to remove an organic material, thereby completing the barrier rib.

The screen printing method is advantageous in that it is performed using relatively simple apparatuses such as a screen printing apparatus and the firing furnace and has a high use efficiency of materials.

The following is a detailed description of the method of forming the barrier rib of the plasma display panel using an etching method.

A barrier rib material such as a frit glass paste is coated on the substrate and is then fired. Afterwards, a dry film resist (DFR) is coated on the resulting structure, and exposure and development processes are then performed. A frit glass layer is etched using an etchant, thus forming a pattern of the barrier rib having an exhaust passage. Thereafter, the dry film resist is removed and then is fired again, thereby completing the barrier rib.

The etching method is advantageous in that it manufactures a large area panel with high definition at low cost, and easily obtains the barrier rib pattern having a variety of shapes.

The following is a detailed description of the method of forming the barrier rib of the plasma display panel using a sandblasting method.

A material for forming the barrier rib is formed on the substrate. A pattern is formed on the material using a mask. Cutting particles such as ceramic particles or calcium carbonate (CaCO₃)-based particulates are blown at a high pressure so that unnecessary portions are cut to complete the barrier rib.

The sandblasting method is advantageous in that it manufactures the barrier rib having a line width less than 50 μm and also manufactures the barrier rib of a vertical wall shape using the pattern of the high procession and high fineness.

The following is a detailed description of the method of forming the barrier rib of the plasma display panel using a squeezing method.

In the squeezing method, a thick resist is coated on the substrate and exposure and development processes are then performed on the thick resist to fill the remaining resist negative (−) pattern with a glass paste. The filled remaining resist negative (−) pattern is fired and then removed, thus completing the barrier rib.

The squeezing method can form the barrier rib having a micro shape because it employs a light source, and is suitable for a glass substrate.

The following is a detailed description of the method of forming the barrier rib of the plasma display panel using a paste photolithography method.

The paste photolithography method uses a photosensitive paste as a material of the barrier rib. In the paste photolithography method, a paste of a photosensitive barrier rib material is thickly coated on the substrate and is then dried. A patterned mask is placed on the paste, and exposure and development processes are then performed on the patterned mask. The remaining mask is fired to complete the barrier rib.

The paste photolithography method using the photosensitive paste as the material of the barrier rib enables the barrier rib to be manufactured more precisely and finer than other fabrication methods of the barrier rib.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display panel comprising:
a substrate; and
a transverse barrier rib and a longitudinal barrier rib formed on an upper portion of the substrate to form discharge cells,
wherein at least one of the transverse barrier rib and the longitudinal barrier rib comprises a first barrier rib and a second barrier rib spaced apart from each other, and
the shape of the first barrier rib is different from the shape of the second barrier rib.

2. The plasma display panel of claim 1, wherein the longitudinal barrier rib partitions the discharge cells each comprising a different phosphor.

3. The plasma display panel of claim 1, wherein the transverse barrier rib partitions the discharge cells each comprising the same phosphor.

4. The plasma display panel of claim 1, wherein the shape of the first barrier rib or the second barrier rib is a straight-line shape, and the shape of the remaining barrier rib is a shape different from the straight-line shape.

5. The plasma display panel of claim 1, wherein a dielectric layer is formed between the first barrier rib and the second barrier rib.

6. A plasma display panel comprising:
a substrate; and
a transverse barrier rib and a longitudinal barrier rib formed on an upper portion of the substrate to form a discharge cell,
wherein at least one of the transverse barrier rib and the longitudinal barrier rib comprises a first barrier rib and a second barrier rib spaced apart from each other at an unequal distance.

7. The plasma display panel of claim 6, wherein a shortest distance between the first barrier rib and the second barrier rib is equal to a distance between the first barrier rib and the second barrier rib corresponding to a first reference line passing through the center of the discharge cell in a direction of the longitudinal barrier rib.

8. The plasma display panel of claim 6, wherein a distance between the first barrier rib and the second barrier rib corresponding to a first reference line passing through the center of the discharge cell in a direction of the longitudinal barrier rib is less than a distance between the first barrier rib and the second barrier rib corresponding to a second reference line passing through the longitudinal barrier rib.

9. The plasma display panel of claim 6, wherein the unequal distance between the first barrier rib and the second barrier rib ranges from 20 μm to 500 μm.

10. A plasma display panel comprising:
a front substrate comprising a first electrode and a second electrode formed in parallel to each other;
a rear substrate comprising a third electrode which is formed to intersect the first electrode and the second electrode; and
a transverse barrier rib and a longitudinal barrier rib for forming discharge cells between the front substrate and the rear substrate,
wherein at least one of the transverse barrier rib and the longitudinal barrier rib comprises a first barrier rib and a second barrier rib spaced apart from each other, and
a distance between a reference line between the first barrier rib and the second barrier rib and the first barrier rib is different from a distance between the reference line and the second barrier rib.

11. The plasma display panel of claim 10, wherein a dielectric layer is formed between the first barrier rib and the second barrier rib.

12. The plasma display panel of claim 10, wherein the first electrode and the second electrode each comprise a metal electrode, and the metal electrode is formed on the front substrate corresponding to the first barrier rib and the second barrier rib.

13. The plasma display panel of claim 10, wherein the longitudinal barrier rib partitions the discharge cells each comprising a different phosphor.

14. The plasma display panel of claim 10, wherein the transverse barrier rib partitions the discharge cells each comprising the same phosphor.

15. The plasma display panel of claim 10, wherein a distance between the first barrier rib and the second barrier rib ranges from 20 μm to 500 μm.
